(19) United States
(12) Patent Application Publication
(10) Pub. No.: US 2014/0304664 A1
(43) Pub. Date: Oct. 9, 2014

(54) PORTABLE DEVICE AND METHOD FOR CONTROLLING THE SAME

(71) Applicant: LG ELECTRONICS INC., Seoul (KR)

(72) Inventors: Doyoung LEE, Seoul (KR); Yongsin KIM, Seoul (KR); Changshik SHIN, Seoul (KR)

(73) Assignee: LG ELECTRONICS INC., Seoul (KR)

(21) Appl. No.: 13/900,196

(22) Filed: May 22, 2013

(30) Foreign Application Priority Data
Apr. 3, 2013 (KR) 10-2013-0036271

(51) Int. Cl. G06F 3/0488

(52) U.S. Cl. CPC G06F 3/0488
USPC 715/863

(57) ABSTRACT

A portable device and a method for controlling the same are disclosed, in which a user may set a timer or alarm more conveniently and more exactly. The portable device comprises a display unit, a sensor unit configured to sense a touch input for the display unit, and a processor configured to control the display unit and the sensor unit, wherein the processor is further configured to display an unlock interface for unlocking a lock state when the portable device is in the lock state, the unlock interface including a current time indicator displaying current time information, the current time indicator including a first zone indicating current hour unit information and a second zone indicating current minute unit information.

This application claims the benefit of the Korean Patent Application No. 10-2013-0036271, filed on Apr. 3, 2013, which is hereby incorporated by reference as if fully set forth herein.

### BACKGROUND OF THE INVENTION

1. Field of the Invention

The present specification relates to a portable device and a method for controlling the same, and more particularly, to a portable device and a method for controlling the same, in which a timer setup interface is provided through an unlock interface for unlocking a lock state of the portable device.

2. Discussion of the Related Art

With the increase of portable devices, users have used various services, such as interpersonal communication, music listening, web surfing, and electronic financial transaction, by using the portable devices. As services provided through the existing computer are provided by a portable device, users could use the above services regardless of time and place. An error operation may occur in the portable device due to unwanted button press caused by portability of the portable device. In order to prevent such an error operation from occurring, a recent portable device is characterized in that a user can operate an application of the portable device only if the user implements an unlock operation even after a display unit is activated by a power button. Accordingly, the user has inconvenience in that the user presses a power button to operate the application and then should find out and touch an icon of a desired application after implementing a touch input for unlocking.

### SUMMARY OF THE INVENTION

Accordingly, the present specification is directed to a portable device and a method for controlling the same, which substantially obviate one or more problems due to limitations and disadvantages of the related art.

An object of the present specification is to provide an interface that may set a timer or alarm in a lock state of a portable device even without unlocking the locking state.

Another object of the present specification is to provide an interface that may set a timer or alarm by using a current time indicator displaying current time information.

Still another object of the present specification is to provide an interface that may set a timer or alarm per time unit in accordance with a user input for each zone by dividing time into hour and minute.

Further still another object of the present specification is to provide an interface that may set a timer or alarm time in accordance with a location or length of a touch input of a user.

Further still another object of the present specification is to provide a timer counting indicator as a graphic user interface in which at least one of length, brightness and size is changed to correspond to counted time.

Additional advantages, objects, and features of the specification will be set forth in part in the description which follows and in part will become apparent to those having ordinary skill in the art upon examination of the following or may be learned from practice of the specification. The objectives and other advantages of the specification may be realized and attained by the structure particularly pointed out in the written description and claims hereof as well as the appended drawings.

To achieve these objects and other advantages and in accordance with the purpose of the specification, as embodied and broadly described herein, a portable device comprises a display unit, a sensor unit configured to sense a touch input for the display unit, and a processor configured to control the display unit and the sensor unit, wherein the processor is further configured to display an unlock interface for unlocking a lock state when the portable device is in the lock state, the unlock interface including a current time indicator displaying current time information, the current time indicator including a first zone indicating current hour unit information and a second zone indicating current minute unit information, display at least one timer setup object corresponding to a time unit of at least one of the first zone and the second zone in a direction when a first touch input is sensed in at least one of the first zone and the second zone, and set a timer according to a second touch input when the second touch input for the timer setup object is sensed.

According to one embodiment, the user may set a timer or alarm more quickly and conveniently even without unlocking the portable device.

Also, according to another embodiment, since a current time indicator, which displays current time information, is used to provide a timer or alarm setup interface, a timer or alarm setup interface which is more intuitive and easy may be provided.

Also, according to another embodiment, since a timer or alarm setup interface, in which time is divided into a hour unit and a minute unit, is provided, a detailed timer or alarm may be set per time unit.

Also, according to another embodiment, since a timer or alarm time is set in accordance with a length of a touch input of the user, a timer or alarm setup interface, which is more intuitive, may be provided.

Also, according to another embodiment, if a timer or alarm time is set, since a graphic user interface, of which brightness or size is changed in accordance with a counted time, is provided as a time count indicator, 1) design effect may be increased and at the same time 2) the indicator more intuitive for the counted time may be provided.

It is to be understood that both the foregoing general description and the following detailed description of the present specification are exemplary and explanatory and are intended to provide further explanation of the specification as claimed.

### BRIEF DESCRIPTION OF THE DRAWINGS

The accompanying drawings, which are included to provide a further understanding of the specification and are incorporated in and constitute a part of this application, illustrate embodiment(s) of the specification and together with the description serve to explain the principle of the specification. In the drawings:

FIG. 1 is a block diagram illustrating a portable device according to one embodiment;

FIG. 2 is a diagram illustrating a device of a lock state according to one embodiment;

FIG. 3 is a diagram illustrating a portable device if a user input is sensed by a current time indicator in accordance with one embodiment;

FIG. 4 is a diagram illustrating a portable device in which a timer setup object is displayed in accordance with one embodiment;

FIG. 5 is a diagram illustrating a portable device in which a timer setup object for a plurality of time zones is displayed in accordance with one embodiment;

FIG. 6 is a diagram illustrating a portable device in which a time count indicator is displayed in accordance with one embodiment;

FIG. 7 is a diagram illustrating a portable device that displays a partial unlock interface in accordance with one embodiment; and

FIG. 8 is a diagram illustrating a portable device in which a timer or alarm is set in accordance with a touch input of one embodiment.

### DETAILED DESCRIPTION OF THE INVENTION

Reference will now be made in detail to the preferred embodiments of the present specification, examples of which are illustrated in the accompanying drawings. Wherever possible, the same reference numbers will be used throughout the drawings to refer to the same or like parts.

Although the terms used in the present specification are selected from generally known and used terms considering their functions in the present specification, the terms can be modified depending on intention of a person skilled in the art, practices, or the advent of new technology. Also, in special case, the terms mentioned in the description of the present specification may be selected by the applicant at his or her discretion, the detailed meanings of which are described in relevant parts of the description herein. Accordingly, the terms used herein should be understood not simply by the actual terms used but by the meaning lying within and the description disclosed herein.

Although the embodiments will be described in detail with reference to the accompanying drawings and the disclosure described by the drawings, it is to be understood that the present specification is not limited by such embodiments.

With the development of the manufacture technology of electronic devices, portable devices have been miniaturized. This specification relates to a mobile electronic device, which will be referred to as a portable device hereinafter. The portable device means various electronic devices having mobility. For example, the portable device includes electronic devices such as a cellular phone, a personal digital assistant (PDA), a notebook computer, a tablet PC, an MP3 player, a CD player, and a DVD player. Hereinafter, the portable device may be abbreviated as a device.

In this specification, the portable device may have a lock state and an unlock state. The lock state of the portable device may mean that 1) the device is operated unlike intention of a user and that 2) specific units of the device are deactivated to prevent unnecessary power consumption of the device from occurring. Alternatively, the lock state of the portable device may mean the state that an unlock interface for unlocking the device is provided. Use of the device of the lock state may be limited partially or fully. If the lock state of the device is released in accordance with an unlock sequence of the device, which is previously set, the user may freely use the device. The unlock state of the device may mean that deactivated specific units are activated. Alternatively, the unlock state of the device may mean the state that a previously set standby screen is displayed on a display unit. The unlock state of the device may be referred to as an active state.

Accordingly, since the user is basically restricted to use the device in the lock state of the device, a timer function should be implemented to set a timer after the lock state of the device is unlocked. However, the device of this specification provides an unlock interface, which includes a timer setup interface, whereby the user may use a timer function even without unlocking the lock state. This is intended to increase access of the user regarding timer setting in such a manner that the timer setup interface is included in the unlock interface as the timer setup function is likely to be used by users. Accordingly, unlike the existing devices of the lock state, the device in this specification may enable timer setting through the user even in the lock state. Also, since the timer may be set immediately using a current time indicator basically provided by the unlock interface without using a separate user interface, the device may provide a timer setup function which is more intuitive.

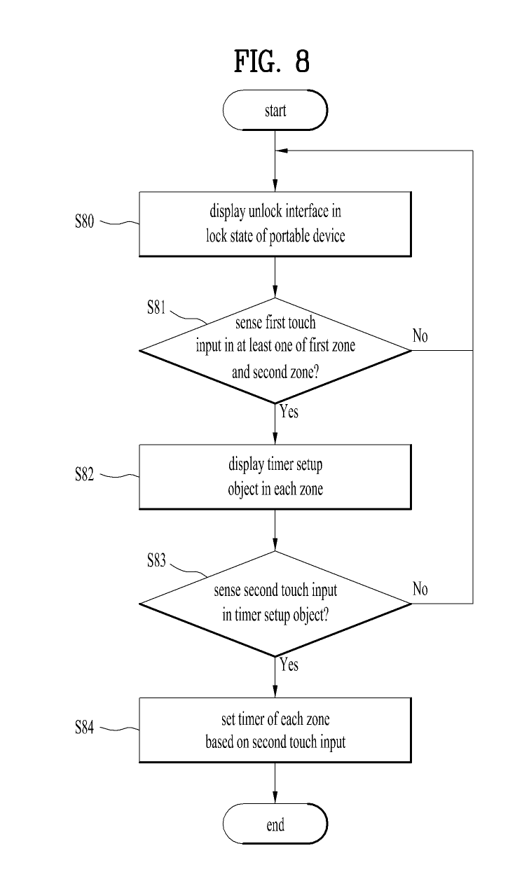

Detailed embodiments of a method for setting a timer by using an unlock interface will be described with reference to FIG. 2 to FIG. 5. Also, in accordance with one embodiment, the device may provide an alarm setup function as well as a timer setup through a timer setup interface. This will be described in more detail with reference to FIG. 8.

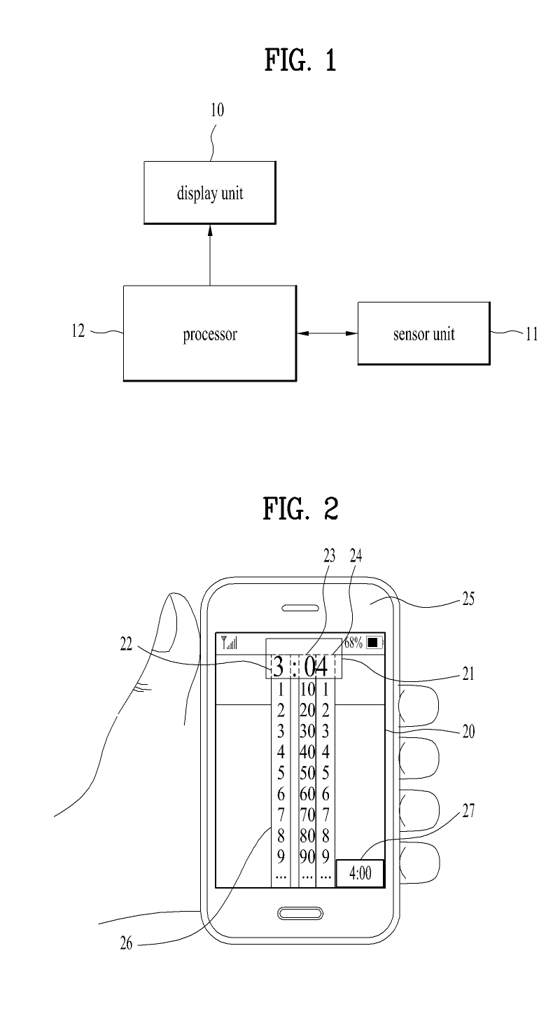

FIG. 1 is a block diagram illustrating a portable device according to one embodiment. In FIG. 1, the device may include a display unit 10, a sensor unit 11, and a processor 12.

The display unit 10 may output image data on a display screen. In the embodiment of this specification, the display unit 10 may output an image on the basis of contents implemented by the processor 12 or a control command of the processor 12. Alternatively, the display unit 10 may output a display page of contents implemented by the processor 12. In this specification, the image may represent still images, moving pictures, or other various images, which may be expressed visually and include the still images and the moving pictures.

The sensor unit 11 may forward a user input or an environment recognized by the device to the processor 12 by using at least one sensor provided in the device. The sensor unit 11 may include at least one sensing means. According to one embodiment, the at least one sensing means may include a touch sensor, a fingerprint sensor, a motion sensor, and a pressure sensor. The sensor unit 11 refers to the aforementioned various sensing means, and may sense various inputs of the user and the environment of the user and forward the sensed result to the processor 12, whereby the processor 12 may perform the operation based on the sensed result. The aforementioned sensors may be included in the digital device 100 as separate elements or may be incorporated into at least one element.

In the meantime, the device may include the sensor unit 11 in the display unit 10. Accordingly, the device may sense various user inputs performed on the display unit 10 through the sensor unit 11. For example, if the sensor unit 11 is a touch sensor, the device may sense various touch inputs of the user, which are performed on the display unit 10. At this time, the sensor unit 11 may sense various touch inputs such as a long-press touch input, a short-press touch input, a drag touch input, a release touch input and a flicking touch input. Also, if the sensor unit 11 includes a fingerprint sensor, the device may collect fingerprint information from the user input sensed on the display unit 10.

The processor 12 may implement various applications, and may process data inside the device. Also, the processor 12 may control contents of the device on the basis of a contents control command. Also, the processor 12 may control each unit of the device, and may control data transmission and reception between the units. Also, if a user input is sensed through the sensor unit 11, the processor 12 may implement a command based on the user input. Particularly, in this specification, the lock state of the device may be unlocked, and a timer or alarm may be set according to the sensed result of the touch input of the user for the device of the lock state.

The processor 12 may partially operate the display unit 10 or the sensor unit 11 in the lock state of the device. In more detail, according to one embodiment, if the sensor unit 11 is a touch sensor unit, it may sense the touch input of the user in a previously set some zone only. According to one embodiment, the processor 12 may sense a touch input of some zone by partially activating the sensor unit 11 provided on the display unit 10. Otherwise, the sensor unit 11 may forward a part of the touch sensed result to the processor 12, whereby the processor 12 may sense the touch input of some zone. Otherwise, the processor 12 may sense the touch input by bypassing or disregarding the sensed result forwarded from the sensor unit 11 in accordance with the sensed location.

The processor 12 may fully operate the display unit 10 and the sensor unit 11 in the unlock state of the device. In this case, the sensor unit 11 may sense the touch input of the user over the entire zone of the display unit 10.

Hereinafter, if each step or operation performed by the portable device starts or is performed by the user input, it is understood that the procedure of generating an input signal in accordance with the user input includes description of the above procedure even without repeated description. Also, it may be expressed that the processor controls the device or at least one unit included in the device in accordance with the user input, and it may be described that the processor may mean the device.

In the meantime, FIG. 1 is a block diagram according to one embodiment. In FIG. 1, respective blocks are shown to logically identify the elements of the device. Accordingly, the aforementioned elements of the device may be provided as one chip or a plurality of chips in accordance with design of the device.

FIG. 2 is a diagram illustrating a device 25 of a lock state according to one embodiment. In more detail, FIG. 2 is a diagram illustrating the device 25 in which the unlock interface 20 is displayed on the display unit 10.

In this specification, the unlock interface 20 represents a user interface provided to unlock the lock state of the device 25. According to one embodiment, the unlock interface 20 may be provided by the device 25 to sense an unlock signal of the user. Alternatively, the unlock interface 20 may be provided by the device 20 to guide a method how to input the unlock signal. In this case, the unlock signal is the input signal of the user, which is intended to unlock the lock state of the device 25, and may include, but not limited to, various signals such as a certain touch input signal and a signal generated by a physical button press provided in the device 25. If the sensed unlock signal is the same as a previously set unlock signal, the device 25 may unlock the lock state. In the meantime, the unlock interface 20 may be displayed on the display unit 10 as the graphic user interface, and various animation effects may be given to the unlock interface 20 in accordance with an unlocking method.

The unlock interface 20 may includes a current time indicator 21 that includes current time information. In more detail, the unlock interface 20 may include the current time indicator 21 that displays current time information on the display unit 10. According to one embodiment, the current time indicator 21 may be divided into a zone 22 indicating current hour unit information and a zone indicating current minute unit information 23 and 24. Moreover, according to another embodiment, the zone indicating current minute information 23 and 24 may be divided into the zone 23 indicating ten minute unit information and the zone 24 indicating one minute unit information. Also, although not shown, according to another embodiment, the zone indicating current hour information may be divided into a zone indicating ten hour unit information and a zone indicating one hour unit information. If a user input is sensed per zone, the device may display at least one timer setup object 26 corresponding to a time unit of each zone in a direction. For example, if the device 25 senses a touch input of the user for a hour unit zone, it may display the timer setup object 26 at an interval of one hour which is a unit time of hour unit information 22. This may equally be applied to the embodiment that minute unit information is divided into ten minute unit information 23 and one minute unit information 24.

In the meantime, the timer setup object 26 in this specification may mean time option provided per unit time to allow the user to set a timer. For example, as shown in FIG. 2, the timer setup object 26 of ten minute unit may mean each of numbers 10, 20, 30, 40, . . . displayed at an interval of ten minutes. Alternatively, the listed numbers may be referred to as the timer setup object 26. The timer setup object 26 may be displayed in a direction, for example in various directions such as up, down, left, right and diagonal directions. The display direction of the timer setup object 26 is not limited to the above examples. Meanwhile, in this specification, the interval means the spatial interface not the time interval.

The device may set a timer by sensing the user input for the timer setup object 26 listed in a direction. For example, if the touch input is sensed in ‘4’ of the timer setup object 26 of the hour information zone 22, the device 25 may set the timer to four hours. Accordingly, if the current time is 3:04, 7:04, at which 4 hours pass from the current time, may be the timer setup time.

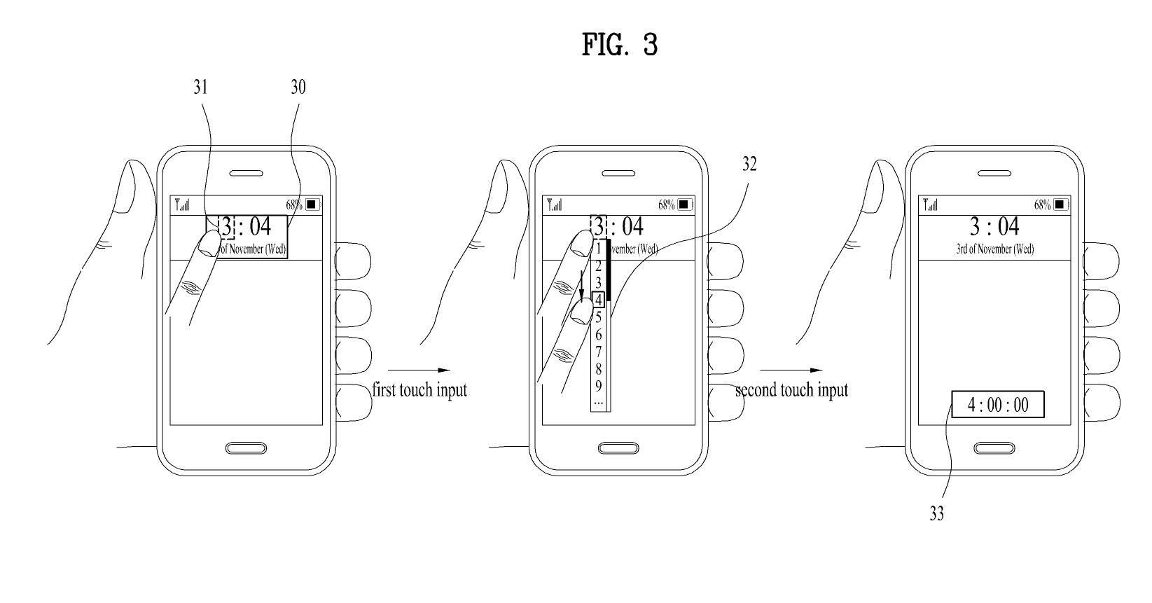

The user may select the timer setup object 26 through a short-press touch input. Alternatively, the user may select the timer setup object 26 through a long-press touch input and a release input. The short-press touch input represents a touch input of which sustain time is less than a previously set time. Also, the long-press touch input represents a touch input of which sustain time is more than the previously set time. The selection method of the timer setup object 26 will be described in more detail with reference to FIG. 3.

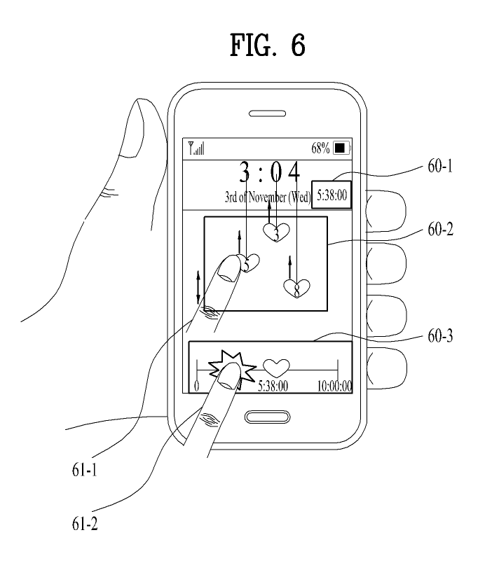

If the timer is set, the device may display the time count indicator 27 indicating time counting. In this specification, the time count indicator means the indicator indicating the remaining time of the set timer. Also, if the alarm is set in accordance with one embodiment, the time count indicator 27 may be functioned as the indicator indicating the alarm time. The time count indicator 27 may indicator the remaining time in various manners. The time count indicator 27 will be described in more detail with reference to FIG. 6.

If the set time of the timer passes, the device 25 may provide the user with a given notice. According to one embodiment, the device 25 may provide notice vibration or notice sound if the timer reaches the set time. According to another embodiment, the device 25 may display a notice alarm window on the display unit 10 if the timer reaches the set time. According to another embodiment, if the device 25 is playing music, it may provide a certain notice to the user by temporarily stopping play or erasing sound.

According to one embodiment, the current time indicator 21 may further include a zone indicating second unit information and data unit information. In this case, the timer may be set for each unit in accordance with the user input for each zone even in case of second unit information and date unit information. For example, if the touch input of the user is sensed in the zone where second unit information is displayed, the device may display the timer setup object of second unit. At this time, the user may set the timer of second unit by selecting the timer setup object. In this way, the timer may be set for a unit of date. In particular, the date unit information may be divided into month unit information, day unit information, and day of week unit information. In this case, the device may set the timer in detail per unit by sensing the touch input for the divided zone of the date unit information. The second unit information or the date unit information may be displayed together with the current time information, or may be displayed separately from the current time information.

According to one embodiment, the current time indicator 21 may provide an alarm setup function as well as timer setup. In this case, if the user input is sensed for each time zone, the device 25 may display an alarm setup object corresponding to each unit time, instead of the timer setup object 26. The alarm setup object may mean alarm option provided in accordance with unit time of each time zone to allow the user to set alarm. In other words, the current time indicator 21 may provide at least one function of the timer and the alarm function. The method for setting a timer or alarm by using the current time indicator 21 will be described in more detail with reference to FIG. 8.

FIG. 3 is a diagram illustrating a portable device if a user input is sensed on a current time indicator 30 in accordance with one embodiment.

As described above, if the user input for the current time indicator 30 is sensed, the device 25 may display the timer setup object 32 corresponding to time unit of the zone where the user input is sensed. The timer setup object 32 may be displayed in such a manner that a single timer setup object or a plurality of timer setup objects may be displayed. Also, the timer setup object 32 may be displayed in a count-up or count-down manner. Also, the timer setup object 32 may be listed in various directions such as up, down, left, right and diagonal directions as described above. However, the timer setup object 32 may be displayed by the user in various manners without limitation to the aforementioned embodiments. Hereinafter, for convenience of description, the touch input of the user for the current time indicator 30 will be referred to a first touch input, and the touch input of the user for the timer setup object 32 will be referred to a second touch input.

If the timer setup object 32 is displayed, the user may select the timer setup object 32 in various manners. According to one embodiment, if a plurality of timer setup objects 32 is displayed in a direction, the user may select the timer setup object 32 corresponding to the set time of the timer through the touch input. For example, as the user touches a hour zone 31, the plurality of timer setup objects 32 of hour unit are displayed, the user may set the time of the timer to reach the time after four hours by touching ‘4’ of the timer setup objects 32 in a short-press touch manner.

According to another embodiment, if a single timer setup object 32 or a plurality of timer setup objects 32 is displayed in a direction, the device may select the timer setup object 32 by sensing the second touch input preceded by the first touch input. In other words, the device may set the timer through a drag touch input from the first touch input to the second touch input. In more detail, the device may set the time of the timer in accordance with the timer setup object 32 corresponding to a release location of the second touch input preceded by the first touch input. Alternatively, the device may set the time of the timer in accordance with a length of the second touch input preceded by the first touch input. In particular, if the timer setup object 32 is listed in the count-up manner, the longer the second touch input becomes, the more increased the time of the timer may be. On the other hand, if the timer setup object 32 is listed in the count-down manner, the longer the second touch input becomes, the more reduced the time of the timer may be.

According to another embodiment, the user may select a desired timer setup object 32 by scrolling the plurality of timer setup objects 32. For example, there is no object desired by the user in the plurality of timer setup objects 32 which are displayed, the user may set the timer by finding out the desired setup object 32 through scrolling and selecting the desired setup object 32. Also, the device may display a scroll bar to display a scroll level.

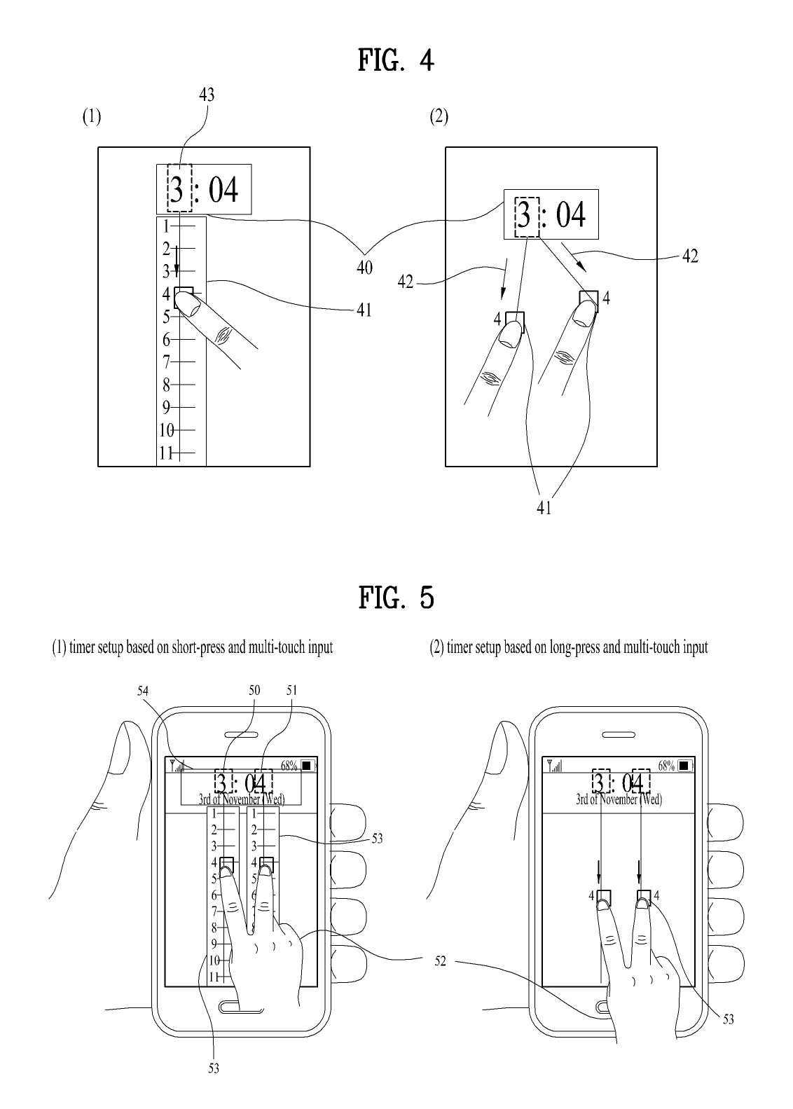

In the meantime, the timers for the respective time unit zones may be independent from each other. For example, if the user desires to set the time of the timer to ‘four hours and four minutes’, the user may set the timer of hour unit zone to ‘4’ and then set the timer of minute unit zone to ‘4’ in due order. In this case, time counting of first set four hours may start regardless of setup of four minutes. In other words, regardless of timer setup of the other time unit zone, the timer may be counted from the set time if the timer is set for each zone. Accordingly, the time of the timer may be set or corrected in real time. According to another embodiment, the timers for a plurality of time unit zones may be set at the same time. This will be described in detail with reference to FIG. 5.

If the time of the timer is set, the device may display the time count indicator 33 indicating counting of the time of the timer.

FIG. 4 is a diagram illustrating a portable device in which a timer setup object is displayed in accordance with one embodiment.

If the device senses the first touch input for the current time indicator 40, it may display the timer setup object 31. In this embodiment, if the device senses the first touch input for a hour zone 43, it displays the timer setup object 41 of hour unit.

The timer setup object 41 may represent time option provided per time unit to allow the user to set the timer. The device may provide an option for timer setup time in various manners through the timer setup object 41 without limitation to the embodiment which will be described later.

In FIG. 4-(1), which relates to one embodiment, if the first touch input is sensed, the device may display a plurality of timer setup objects 41 in a direction. The timer setup objects 41 may be listed in various directions such as up, down, left, right and diagonal directions. The listed direction of the timer setup objects 41 is not limited to the direction as shown. The timer setup object 41 may include, but not limited to, various graphic interfaces that may indicate number, scale and time. In particular, if the timer setup objects 41 are listed as numbers, they may be listed in the count-up or count-down manner as described above. If the second touch input for the timer setup object 41 is sensed, the device may set the timer in accordance with the second touch input. The method for setting the timer based on the second touch input is the same as described in FIG. 3.

In FIG. 4-(2), which relates to another embodiment, the device may a timer setup object 41 in response to the second touch input. In this case, the device may at least one timer setup object 41 in accordance with a location or length 42 of the second touch input. For example, if the second touch input is a short-press touch input, the device may display the timer setup object 41 corresponding to a point where the second touch input is sensed. For another example, if the second touch input is a long-press touch input preceded by the first touch input in a direction, the device may display the timer setup object 41 in accordance with the length of the second touch input. In particular, if the timer setup object 41 is a number, the device may display the timer setup objects 41 in due order as the length of the second touch input is increased. In this case, the device may display the timer setup objects 41 in the count-up or count-down manner. If the timer setup objects 41 are displayed in the count-up manner, the length of the second touch input may be proportional to the timer setup time. On the other hand, if the timer setup objects 41 are displayed in the count-down manner, the length of the second touch input may be inversely proportional to the timer setup time.

FIG. 5 is a diagram illustrating a portable device in which a timer setup object for a plurality of time zones is displayed in accordance with one embodiment. In more detail, FIG. 5 is a diagram illustrating a portable device in which a multi-touch input is sensed on a current time indicator 54. In this specification, the multi-touch input may mean the touch input if a plurality of touch points are sensed on the display unit at the same time. In the embodiment of FIG. 5, the first touch input may mean the multi-touch input sensed in a plurality of time unit zones.

According to one embodiment, if the first touch input is sensed in the hour unit zone and the minute unit zone at the same time, the device may display the timer setup objects 53 corresponding hour unit and minute unit at the same time. This may equally be applied to another embodiment that the minute unit zone is divided into a ten minute unit zone and a one minute unit zone.

If the timer setup object 53 is displayed for a plurality of time unit zones in accordance with the first touch input, the device may set the timer by sensing the second touch input 52 for the timer setup object 53. In this embodiment, in the same manner as the first touch input, the second touch input 52 may mean the multi-touch input sensed in the plurality of timer setup objects.

According to one embodiment, the second touch input 52 may be the multi-touch input and a short-press touch input sensed in the plurality of time zones. The user may set the timer for the plurality of time zones by touching the timer setup objects 53 of two zones in a short-press manner at the same time. In other words, if the short-press touch inputs for the timer setup objects 53 of the hour zone 50 and the minute zone 51 are sensed, the device may set the timer in accordance with the sensed result.

According to another embodiment, the second touch input 52 may be the multi-touch input and a long-press touch input sensed in the plurality of time zones. In more detail, the second touch input 52 may be the multi-touch input preceded by the first touch input. In this case, the device may set the timer of each time unit in accordance with the timer setup objects 53 corresponding to a plurality of release points of the second touch input 52. The method for setting the timer in accordance with the length of the second touch input will correspond to or be the same as that described in FIG. 4.

FIG. 6 is a diagram illustrating a portable device in which a time count indicator is displayed in accordance with one embodiment.

In this specification, time count indicators 60-1, 60-2 and 60-3 indicate the indicators indicating the remaining time of the timer. Alternatively, the time count indicators 60-1, 60-2 and 60-3 may mean the indicators indicating alarm time if alarm is set in accordance with one embodiment. The time count indicators 60-1, 60-2 and 60-3 may indicate counting time in various manners. In this specification, the counting time may represent the time remaining after the set timer is counted. Alternatively, the counting time may represent the time of the timer which is being counted.

According to one embodiment, the time count indicator 60-1 may be displayed as a number indicating the counting time of the timer. For example, after the timer is set to 6 hours, if 22 minutes pass, the time count indicator may be displayed as “5:38:00” as shown in FIG. 6. Alternatively, according to another embodiment, the time count indicators 60-2 and 60-3 may be displayed as the graphic user interfaces of which location, length, size or brightness is changed in accordance with the counted time. For example, the image 60-2, of which length is controlled in accordance with the time of the timer, may be displayed in each time unit zone. The length of the image 60-2 may be changed in accordance with the counted time. The user may intuitively know the counting time of the timer through the length of the image 60-2. Alternatively, according to another embodiment, the time count indicator 60-3 may be displayed as the image 60-3 of which location is changed in accordance with the counting time. In more detail, the location of the time count indicator 60-3 may be changed in accordance with the counted time, and the user may know the remaining time of the timer through the location 60-3 of the image. In the meantime, the time count indicators 60-1, 60-2 and 60-3 may be located anywhere on the display unit, and their locations may be set by the user.

If the user input is sensed on the time count indicators 60-1, 60-2 and 60-3, the device may correct the counting time in accordance with the sensed result. In more detail, if the user input is sensed on the time count indicators 60-1, 60-2 and 60-3, the time of the timer which is being counted may be increased or decreased in accordance with the user input.

According to one embodiment, if the time count indicator 60-2 indicates the counting time as the length of the image, the user may correct the time of the timer by performing a drag 61-1 in a direction that the length of the image becomes longer or shorter after pressing an end point of the time count indicator 60-2.

According to another embodiment, if the time count indicator 60-3 indicates the counting time by using the location of the image, the user may predict a location corresponding to a desired set time of the timer and correct the time of the timer by touching the location through a short-press touch 61-2.

Also, according to another embodiment, in the same manner as the method for setting the timer, the time of the timer may be corrected in accordance with the touch input of the user for each time zone displayed on the time count indicator. For example, if the touch input of the user for the hour zone of the time count indicator is sensed, the device may display a timer correction object corresponding hour unit. In this case, the device may correct the time of the timer in accordance with the touch input of the user for the timer correction object.

Also, according to another embodiment, the time of the timer may be corrected in such a manner that the timer is newly set. The counting time may be corrected in various manners, and the aforementioned embodiments of the counting time may be used in combination. The counting time is not limited to the aforementioned embodiments.

If the set time of the timer passes, the device may provide a given notice, and details of the notice is the same as described in FIG. 2.

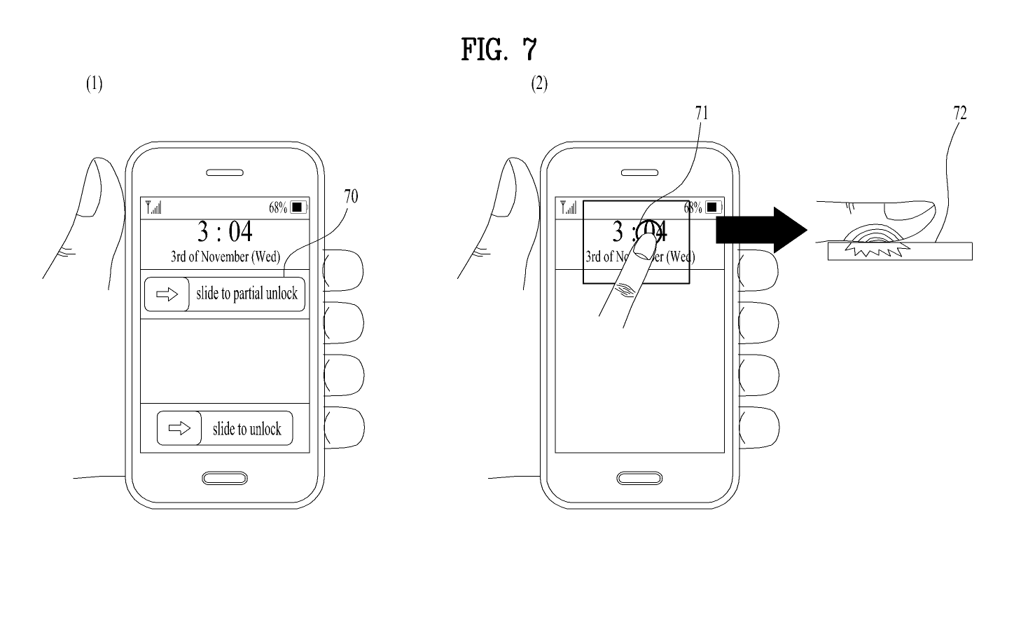

FIG. 7 is a diagram illustrating a portable device that displays a partial unlock interface in accordance with one embodiment.

The device is locked to prevent the device from being operated in error unlike intention of the user. Accordingly, if the device is in the lock state, its functions may be restricted. However, this specification relates to a device that may set the timer even without unlocking the lock state, and the timer setup function may be activated partially even in the lock state of the device. Accordingly, since the device is in the unlock state for the timer or alarm function, the timer or alarm function may be operated differently from intention of the user. In order to prevent the timer or alarm function from being operated differently from intention of the user, as one embodiment, the device may provide partial unlock interfaces 70, 71 and 72 for the current time indicator to prevent the timer from being set in error. The partial unlock interfaces 70, 71 and 72 may mean the unlock interfaces 70, 71 and 72 provided to partially activate the timer or alarm function only in the lock state of the device.

The device may activate the timer setup function of the current time indicator if the user input value is the same as the previously set value. According to one embodiment, if the touch input pattern of the user is the same as the previously set pattern, the device of the lock state may partially activate the timer setup function. At this time, the partial unlock interface 70 may be displayed as the graphic user interface that guides the touch input pattern of the user. Otherwise, the device of the lock state may partially activate the timer setup function if the length of the user touch input exceeds a threshold. Otherwise, the device of the lock state may partially activate the timer setup function if the sustain time of the touch input of the user exceeds a previously set time (71). Otherwise, if the fingerprint sensed from the touch input of the user is coincident with previously set fingerprint information, the device of the lock state may partially activate the timer setup function (72).

In other words, the device may provide the partial unlock interface that activates a timer or alarm function in various manners. The partial unlock interface may be provided in a combination manner of the aforementioned embodiments, and is not limited to the aforementioned embodiments.

FIG. 8 is a diagram illustrating a portable device in which a timer or alarm is set in accordance with a touch input of one embodiment.

First of all, if the portable device is in the lock state, the device may display the unlock interface (S80). If the unlock interface is the interface provided to the user to unlock the device, and in this specification, the unlock interface may include a current time indicator that provides current time information. The current time indicator may be divided into a first zone indicating current hour unit information and a second zone indicating current minute unit information.

Next, the device may determine whether the first touch input is sensed in at least one of the first zone and the second zone (S81).

If the first touch input is sensed, the device may display the timer setup object corresponding to a time unit of each zone in each zone (S82). In particular, the timer setup object may be displayed in a direction per time unit of each zone. In more detail, the timer setup object may be displayed in accordance with a unit time interval of each time zone. For example, the timer setup object of a minute unit may be listed at a previously set minute unit interval of a one minute unit, three-minute unit, or five-minute unit. The unit time interval of each time zone may be set or changed in accordance with the system or user setup. In addition, the timer setup object may be displayed in various manners as described with reference to FIG. 2.

On the other hand, if the first touch input is not sensed, the device may return to the step of displaying the unlock interface (S80).

If the timer setup object is displayed, the device may determine whether the second touch input for the timer setup object is sensed (S83).

If the second touch input is sensed, the device may set the timer per time unit in accordance with the second touch input (S84). In more detail, the device may set the timer in accordance with a type, location or length of the sensed second touch input. In addition, the method for setting the timer based on the second touch input will be performed in various manners as described with reference to FIG. 3 and FIG. 4.

Moreover, although not shown in the flow chart, if the timer is set, the device may display the time count indicator indicating the count time. The time count indicator has been described in more detail with reference to FIG. 6.

In the meantime, according to one embodiment, the device may provide the alarm setup function as well as the timer setup function through the current time indicator.

In the step at which the first touch input is sensed, the device may display the alarm setup object corresponding to a time unit of each zone in each zone (S82). The detailed description of the alarm setup object corresponds to or the same as the description of the aforementioned timer setup object in FIG. 2.

On the other hand, if the first touch input is not sensed, the device may return to the step of displaying the unlock interface (S80).

If the alarm setup object is displayed, the device may determine whether the third touch input for the alarm setup object is sensed (S83).

If the third touch input is sensed, the device may set the alarm per time unit in accordance with the third touch input (S84). In more detail, the device may set the alarm in accordance with a type, location or length of the sensed third touch input. In addition, the method for setting the alarm based on the third touch input will be performed in various manners as described with reference to FIG. 3 and FIG. 4.

Moreover, although not shown in the flow chart, if the alarm is set, the device may display the time count indicator indicating the alarm time. The time count indicator has been described in more detail with reference to FIG. 6.

Moreover, although the description may be made for each of the drawings, the embodiments of the respective drawings may be incorporated to achieve a new embodiment. A computer readable recording medium where a program for implementing the embodiments is recorded may be designed in accordance with the need of the person skilled in the art within the scope of the present specification.

Also, the device and the method for controlling the same are not limited to the aforementioned embodiments, and all or some of the aforementioned embodiments may selectively be configured in combination so that various modifications may be made in the aforementioned embodiments.

It will be apparent to those skilled in the art that the present specification can be embodied in other specific forms without departing from the spirit and essential characteristics of the specification. Thus, the above embodiments are to be considered in all respects as illustrative and not restrictive. The scope of the specification should be determined by reasonable interpretation of the appended claims and all change which comes within the equivalent scope of the specification are included in the scope of the specification.

In this specification, both the product invention and the method invention have been described, and description of both inventions may be made complementally if necessary.

What is claimed is:

1. A portable device comprising:
a display unit;
a sensor unit configured to sense a touch input for the display unit; and
a processor configured to control the display unit and the sensor unit,
wherein the processor is further configured to:
display an unlock interface for unlocking a lock state when the portable device is in the lock state, the unlock interface including a current time indicator displaying current time information, the current time indicator including a first zone indicating current hour unit information and a second zone indicating current minute unit information,
display at least one timer setup object corresponding to a time unit of at least one of the first zone and the second zone in a direction when a first touch input is sensed on at least one of the first zone and the second zone, and
set a timer according to a second touch input when the second touch input for the timer setup object is sensed.

2. The portable device according to claim 1, wherein, when the second touch input is sensed as a touch input preceded by the first touch input, the processor is configured to set the timer according to the timer setup object corresponding to a release point of the second touch input.

3. The portable device according to claim 1, wherein, when the second touch input is sensed, the processor is configured to display the timer setup object corresponding to a location of the second touch input.

4. The portable device according to claim 1, wherein, when the second touch input is sensed, the processor is configured to display the timer setup object corresponding to a length of the second touch input in a direction.

5. The portable device according to claim 1, wherein the second zone includes a third zone indicating ten-minute unit information and a fourth zone indicating one-minute unit information, and
the processor is configured to display the at least one timer setup object corresponding to time unit of at least one of the third zone and the fourth zone when a third touch input is sensed on at least one of the third zone and the fourth zone, and set the timer according to a fourth touch input when the fourth touch input for the timer setup object is sensed.

6. The portable device according to claim 1, wherein the current time indicator further includes a date zone displaying current date information, the date zone including a fifth zone indicating month unit information, a sixth zone indicating day unit information, and a seventh zone indicating day of week unit information.

7. The portable device according to claim 1, wherein, when the first touch input corresponds to a multi-touch input sensed at the same time in the first zone and the second zone, the processor is configured to display the timer setup objects corresponding to the time unit of the first zone and the second zone, at the same time.

8. The portable device according to claim 1, wherein, when a time of the timer is set, the processor is further configured to display a time count indicator, which indicates counting the set time of the timer, on the display unit.

9. The portable device according to claim 8, wherein the time count indicator includes a graphic user interface of which size, length or brightness is controlled according to the counted time.

10. The portable device according to claim 9, wherein, when a fifth touch input for the time count indicator is sensed, the processor is configured to increase or decrease the time of the timer, which is being counted, according to a location of the fifth touch input.

11. The portable device according to claim 1, wherein, when the first touch input is sensed, the processor is configured to display at least one alarm setup object corresponding to the time unit of at least one of the first zone and the second zone, and
wherein when a sixth touch input for the alarm setup object is sensed, the processor is further configured to set an alarm according to the sixth touch input.

12. A method for controlling a portable device, the method comprising the steps of:
displaying an unlock interface for unlocking a lock state when the portable device is in the lock state, the unlock interface including a current time indicator displaying current time information, the current time indicator including a first zone indicating current hour unit information and a second zone indicating current minute unit information;
displaying at least one timer setup object corresponding to a time unit of at least one of the first zone and the second zone in a direction when a first touch input is sensed on at least one of the first zone and the second zone; and
setting a timer according to a second touch input when the second touch input for the timer setup object is sensed.

13. The method according to claim 12, when the second touch input is sensed as a touch input preceded by the first touch input, further comprising the step of setting the timer according to the timer setup object corresponding to a release point of the second touch input.

14. The method according to claim 12, when the second touch input is sensed, further comprising the step of displaying the timer setup object corresponding to a location of the second touch input.

15. The method according to claim 12, when the second touch input is sensed, further comprising the step of displaying the timer setup object corresponding to a length of the second touch input in a direction.

16. The method according to claim 12, wherein the second zone includes a third zone indicating ten-minute unit information and a fourth zone indicating one-minute unit information, and the method further comprises displaying the at least one timer setup object corresponding to a time unit of at least one of the third zone and the fourth zone when a third touch input is sensed on at least one of the third zone and the fourth zone, and setting the timer according to a fourth touch input when the fourth touch input for the timer setup object is sensed.

17. The method according to claim 12, wherein the current time indicator further includes a date zone displaying current date information, the date zone including a fifth zone indicating month unit information, a sixth zone indicating day unit information, and a seventh zone indicating day of week unit information.

18. The method according to claim 12, when the first touch input corresponds to a multi-touch input sensed at the same time in the first zone and the second zone, further comprising the step of displaying the timer setup objects corresponding to the time unit of the first zone and the second zone, at the same time.

19. The method according to claim 12, when a time of the timer is set, further comprising the step of displaying a time count indicator, which indicates counting the set time of the timer, on a display unit.

20. The method according to claim 19, wherein the time count indicator includes a graphic user interface of which size, length or brightness is controlled according to the counted time.

21. The method according to claim 20, when a fifth touch input is sensed in the time count indicator, further comprising the step of increasing or decreasing the time of the timer, which is being counted, according to a location of the fifth touch input.

22. The method according to claim 12, further comprising the steps of displaying at least one alarm setup object corresponding to the time unit of at least one of the first zone and the second zone when the first touch input is sensed, and
setting an alarm according to a sixth touch input when the sixth touch input for the alarm setup object is sensed.
